(19) United States
(12) Patent Application Publication
(10) Pub. No.: US 2026/0365892 A1
(43) Pub. Date: Nov. 19, 2026

(54) ELECTRICALLY VARIABLE ADHESIVE SHEET

(71) Applicant: INNOX ADVANCED MATERIALS CO., LTD., Asan-si (KR)

(72) Inventors: Jong Hoon LEE, Asan-si (KR); Myung Sup JUNG, Asan-si (KR); Soyeon BAE, Asan-si (KR)

(21) Appl. No.: 19/661,627

(22) Filed: Apr. 28, 2026

(30) Foreign Application Priority Data
Apr. 30, 2025 (KR) 10-2025-0057707

(51) Int. Cl. C09J 9/02; C09J 4/06; C09J 7/10; C09J 7/38; C09J 11/06

(52) U.S. Cl. CPC C09J 9/02; C09J 4/06; C09J 7/10; C09J 7/385; C09J 11/06; C09J 2203/33; C09J 2203/37; C09J 2301/314; C09J 2301/408; C09J 2301/416; C09J 2400/166

(57) ABSTRACT

The present disclosure provides an electrically variable adhesive sheet comprising an adhesive layer which is a photocured product of an adhesive composition including a binder resin, a (meth)acrylate-based monomer, a UV initiator, and an ionic liquid, and having an adhesive strength of 10 N/inch or more as measured after 500 hours at 85 °C and 85% relative humidity (R.H.).

### CROSS-REFERENCE TO RELATED APPLICATIONS

This application claims the priority of Korean Patent Application No. 10-2025-0057707 filed on Apr. 30, 2025 in the Korean Intellectual Property Office, the disclosures of which are hereby incorporated by reference in their entirety.

### BACKGROUND

### Technical Field

The present disclosure relates to an electrically variable adhesive sheet, and more specifically, to an electrically variable adhesive sheet including an adhesive layer which is a photocured product having excellent environmental reliability and exhibiting excellent adhesive strength even under a high-temperature and high-humidity environment.

### Related Art

In manufacturing processes of products and the like, there is an increasing market demand for rework to improve yield or for recycling by disassembling and recovering parts after use, and the like. Accordingly, in bonding members, a re-peelable adhesive sheet is used, which exhibits excellent adhesive strength while being easily peelable when necessary for rework, recycling, or the like.

Conventionally, re-peelable adhesive sheets have been peeled by irradiating heat or light (UV). However, there have been many limitations in that, in order to peel the adhesive sheet by light irradiation, the sheet needs to be transparent, and in order to peel the adhesive sheet by heat, the material of the adhesive sheet needs to be thermally stable.

Accordingly, there is a demand for an electrically variable adhesive tape that can be peeled by electricity through application of a voltage, rather than by heat or light.

### SUMMARY

### Technical Problem

An object of the present disclosure is to provide an electrically variable adhesive sheet including a photocurable adhesive layer and exhibiting excellent adhesive strength even under high temperature and high humidity, thereby having excellent environmental reliability.

Another object of the present disclosure is to provide an electrically variable adhesive sheet that can be easily peeled by electricity through application of a voltage.

The objects of the present disclosure are not limited to the above-mentioned objects, and other objects and advantages of the present disclosure not mentioned above can be understood by the following description, and will be more clearly understood by embodiments of the present disclosure. In addition, it will be easily understood that the objects and advantages of the present disclosure can be realized by means indicated in the claims and combinations thereof.

### Technical Solution

The present disclosure may provide an electrically variable adhesive sheet comprising an adhesive layer which is a photocured product of an adhesive composition including a binder resin, a (meth)acrylate-based monomer, a UV initiator, and an ionic liquid, and having an adhesive strength of 10 N/inch or more as measured after 500 hours at 85 °C and 85% relative humidity (R.H.).

The binder resin may comprise at least one UV-curable resin selected from the group consisting of a (meth)acrylate-based resin and a urethane acrylate-based resin.

The (meth)acrylate-based monomer may include ethyl (meth)acrylate, butyl (meth)acrylate, ethylhexyl (meth)acrylate, isobornyl (meth)acrylate, or a combination thereof.

The ionic liquid may include a cation having the structure of Formula 1 below:

The ionic liquid may include at least one anion selected from the group consisting of Br⁻, AlCl₄⁻, Al₂Cl₇⁻, NO₃⁻, BF₄⁻, PF₆⁻, CH₃COO⁻, CF₃COO⁻, CF₃CO₃⁻, CF₃SO₃⁻, (CF₃SO₂)₂N⁻, (CF₃SO₂)₃C⁻, AsF⁻, SbF⁻, CF₃(CF₂)₃SO₃⁻, (CF₃CF₂SO₂)₂N⁻, CF₃CF₂CF₂COO⁻, (FSO₂)₂N⁻, and combinations thereof.

The UV initiator may include at least one selected from the group consisting of alpha-hydroxyketone-based initiators, phenylglyoxylate-based initiators, benzyldimethyl-ketal-based initiators, alpha-aminoketone-based initiators, monoacylphosphine-based initiators, bisacylphosphine-based initiators, phosphine oxide-based initiators, metallocene-based initiators, iodonium salt-based initiators, and combinations thereof.

The electrically variable adhesive sheet may exhibit a decrease in adhesive strength upon application of a voltage, and may have an adhesive strength of 0 to 1 N/inch after application of a voltage of 60 V for 10 minutes.

The electrically variable adhesive sheet may include a metal layer on one surface of the adhesive layer, or may include a metal layer on one surface of the adhesive layer and a release film on the other surface thereof, wherein the adhesive layer may have a thickness of 10 μm to 300 μm.

The electrically variable adhesive sheet may be for a battery package.

### Advantageous Effects

The electrically variable adhesive sheet according to the present disclosure includes a photocurable adhesive layer and can exhibit excellent adhesive strength even under high temperature and high humidity, thereby providing excellent environmental reliability.

In addition, the electrically variable adhesive sheet according to the present disclosure can be easily peeled by electricity through application of a voltage.

In addition to the above-described effects, the specific effects of the present disclosure will be described together with the specific matters for implementing the disclosure below.

### BRIEF DESCRIPTION OF THE DRAWINGS

FIG. 1 schematically illustrates a cross-sectional view of an electrically variable adhesive sheet according to one embodiment of the present disclosure.

FIG. 2 schematically illustrates a cross-sectional view of an electrically variable adhesive sheet according to another embodiment of the present disclosure.

FIG. 3 schematically illustrates a phenomenon in which peeling occurs by applying a voltage to an electrically variable adhesive sheet in one embodiment of the present disclosure.

FIG. 4 schematically illustrates that an electrically variable adhesive sheet is used for a battery package in one embodiment of the present disclosure.

### DETAILED DESCRIPTION OF THE INVENTION

The above-described objects, features, and advantages will be described in detail, and thus those skilled in the art may easily implement the technical idea of the present disclosure. In describing the present disclosure, if it is determined that detailed descriptions of the known technology related to the present disclosure may unnecessarily obscure the gist of the present disclosure, the detailed description thereof will be omitted. Hereinafter, preferred embodiments according to the present disclosure will be described in detail.

When any component is disposed “on (or under)” a component or “above (or below)” a component below, this may mean not only that any component is disposed in contact with the upper surface (or lower surface) of said component, but also that other components may be interposed between said component and any component disposed on (or under) said component.

In the present specification, the electrically variable adhesive sheet may be an adhesive tape having a tape-like form.

In the present specification, “room temperature” means 25 °C.

In the present specification, terms such as “one surface,” “the other surface,” and “both surfaces” are used to distinguish one component from another component, and the components are not limited by the terms.

In the present specification, “(meth)acrylate” may mean to include both acrylate and methacrylate.

In the present specification, “weight average molecular weight” means a converted value relative to standard polystyrene measured by a Gel Permeation Chromatograph (GPC).

Hereinafter, an electrically variable adhesive sheet according to some embodiments of the present disclosure will be described.

The present disclosure relates to an electrically variable adhesive sheet that exhibits excellent adhesive strength when no voltage is applied and, when voltage is applied, can be peeled with a small force by passing electricity therethrough.

In one embodiment of the present disclosure, the electrically variable adhesive sheet includes an adhesive layer, wherein the adhesive layer is a photocured product of an adhesive composition including a binder resin, a (meth)acrylate-based monomer, a UV initiator, and an ionic liquid.

Conventionally, for an electrically variable adhesive sheet, a thermosetting adhesive composition has been mainly used as an adhesive layer. Since the thermosetting adhesive composition includes a solvent, it has advantages in that dissolution among materials in the adhesive composition is easy and there is no particular problem in adjusting compatibility among the materials. On the other hand, the thermoset product contains a small amount of solvent even after a drying process, and thus has a problem of poor environmental reliability, such as generation of bubbles in an environment of high temperature, etc.

Accordingly, the electrically variable adhesive sheet is configured to include an adhesive layer using a photocurable adhesive composition, rather than a thermosetting adhesive composition. Meanwhile, since the photocurable adhesive composition does not include a solvent, it may not be easy to dissolve the materials included in the adhesive composition, and the composition may easily change into a gel form upon mixing. In addition, compatibility among the materials constituting the adhesive composition may be poor, and accordingly, manufacture into a sheet may be difficult and properties may deteriorate.

In particular, when an adhesive layer included in a conventional electrically variable adhesive sheet is attached to a conductive adherend to form a bonded body and the bonded body is placed under a high-temperature and high-humidity environment, there has been a problem in that adhesive strength between the adhesive layer constituting the electrically variable adhesive sheet and the conductive substrate, which is the conductive adherend, is reduced, so that peeling easily occurs. Accordingly, the conventional electrically variable adhesive sheet has had a problem of poor reliability as a member.

The electrically variable adhesive sheet includes an adhesive layer that is a photocured product of an adhesive composition, and can exhibit excellent adhesive strength even under a harsh environment of high temperature and high humidity by controlling the composition, preparation method, and the like of the adhesive composition. Specifically, the electrically variable adhesive sheet including the adhesive layer can exhibit excellent environmental reliability with an adhesive strength of 10 N/inch or more as measured after 500 hours at 85 °C and 85% relative humidity (R.H.).

Hereinafter, each component constituting the adhesive composition will be described.

### <Binder Resin>

The adhesive composition includes a binder resin. Here, the binder resin means a base resin occupying the largest weight ratio among the components constituting the adhesive composition. The binder resin is not particularly limited as long as it is a material that is generally used as an adhesive in the electrically variable adhesive sheet, has adhesiveness, and is UV-curable. For example, the binder resin may include at least one UV-curable resin selected from the group consisting of a (meth)acrylate-based resin and a urethane acrylate-based resin. For example, the binder resin may be a (meth)acrylate-based resin, and thus, can more easily provide high-temperature and high-humidity reliability.

The binder resin may be obtained by (co)polymerizing monomer components. For example, it may be obtained by copolymerizing an alkyl (meth)acrylate and a monomer having a crosslinkable functional group.

The alkyl (meth)acrylate may include at least one selected from the group consisting of methyl (meth)acrylate, ethyl (meth)acrylate, n-propyl (meth)acrylate, isopropyl (meth)acrylate, n-butyl (meth)acrylate, t-butyl (meth)acrylate, isobutyl (meth)acrylate, 2-ethylhexyl (meth)acrylate, 2-ethylbutyl (meth)acrylate, pentyl (meth)acrylate, hexyl (meth)acrylate, cyclohexyl (meth)acrylate, n-octyl (meth)acrylate, isooctyl (meth)acrylate, isononyl (meth)acrylate, decyl (meth)acrylate, dodecyl (meth)acrylate, tridecyl (meth)acrylate, tetradecyl (meth)acrylate, octadecyl (meth)acrylate, isobornyl (meth)acrylate, and combinations thereof.

The monomer having a crosslinkable functional group may be selected without particular limitation as long as it can provide a crosslinkable functional group to a polymer produced by polymerization with the alkyl (meth)acrylate monomer.

For example, the crosslinkable functional group may be a hydroxyl group. The monomer having the hydroxyl group may be, for example, hydroxyalkyl (meth)acrylate such as 2-hydroxyethyl (meth)acrylate, 2-hydroxypropyl (meth)acrylate, 4-hydroxybutyl (meth)acrylate, 6-hydroxyhexyl (meth)acrylate, or 8-hydroxyoctyl (meth)acrylate; and/or hydroxypolyalkylene glycol (meth)acrylate such as hydroxypolyethylene glycol (meth)acrylate or hydroxypolypropylene glycol (meth)acrylate, but is not limited thereto.

### <Monomer>

The adhesive composition includes a (meth)acrylate-based monomer. The adhesive composition is a photocurable composition and is a solvent-free composition that does not include a solvent. By including the (meth)acrylate-based monomer, the adhesive composition can adjust solubility among materials in the adhesive composition, thereby adjusting compatibility among the materials in the adhesive composition. Specifically, the (meth)acrylate-based monomer may include ethyl (meth)acrylate, butyl (meth)acrylate, ethylhexyl (meth)acrylate, isobornyl (meth)acrylate, or a combination thereof. For example, the (meth)acrylate-based monomer may include isobornyl (meth)acrylate, thereby increasing the glass transition temperature (Tg) of the adhesive layer, increasing the cohesive strength, and increasing the modulus. In addition, the (meth)acrylate-based monomer may include ethylhexyl (meth)acrylate, thereby decreasing the Tg of the adhesive layer and lowering the modulus. Preferably, the (meth)acrylate-based monomer may include isobornyl (meth)acrylate and ethylhexyl (meth)acrylate. Accordingly, solubility among materials in the adhesive composition can be improved, and compatibility among the materials in the adhesive composition can be improved.

In order to exhibit excellent adhesive strength even under high temperature and high humidity, the (meth)acrylate-based monomer may not include a (meth)acrylate-based monomer having a hydroxyl group, such as hydroxyethyl (meth)acrylate and 4-hydroxybutyl (meth)acrylate.

The adhesive composition may not include, as a monomer, an acid such as acrylic acid. Accordingly, it is possible to prevent a conductive substrate such as a metal layer from being easily oxidized.

The adhesive composition may include 50 parts by weight to 80 parts by weight of the binder resin and 20 parts by weight to 50 parts by weight of the (meth)acrylate-based monomer, based on 100 parts by weight of the total content of the binder resin and the (meth)acrylate-based monomer.

### <Ionic Liquid>

The adhesive composition includes an ionic liquid. The ionic liquid is an ionizable material, and may allow the adhesive sheet to be peeled in an electrically variable manner when a voltage is applied thereto. The ionic liquid is a salt that is liquid at room temperature (about 25 °C), and includes an anion and a cation. The ionic liquid may be a molten salt (room-temperature molten salt) composed of one pair of an anion and a cation and being liquid at 25 °C.

The ionic liquid may include, as the cation, an imidazolium-based cation. Specifically, the ionic liquid may include a cation having the structure of Formula 1 below:

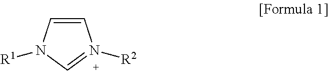

wherein R₁ may be a linear or branched alkyl group having 3 or more carbon atoms, and R² may be a linear or branched alkyl group having 1 to 2 carbon atoms. For example, R₁ may be a linear or branched alkyl group having 3 to 6 carbon atoms, and R² may be a linear or branched alkyl group having 1 to 2 carbon atoms.

The adhesive composition can improve compatibility with materials included in the adhesive composition by including, as the cation, a cation having the above structure. More specifically, the cation may have, as substituents R¹ and R², alkyl groups having the above lengths. For example, the cation may include, as R¹, a linear or branched alkyl group having 3 or more carbon atoms, thereby improving compatibility with the (meth)acrylate-based monomer included in the adhesive composition.

For example, the cation of the ionic liquid may be at least one selected from the group consisting of 1-propyl-3-methylimidazolium cation, 1-butyl-3-methylimidazolium cation, 1-pentyl-3-methylimidazolium cation, 1-hexyl-3-methylimidazolium cation, 1-propyl-3-ethylimidazolium cation, 1-butyl-3-ethylimidazolium cation, 1-pentyl-3-ethylimidazolium cation, 1-hexyl-3-ethylimidazolium cation, and the like. It may be preferable to select, as the cation, a cation having a molecular weight of 160 g/mol or less.

An anion of the ionic liquid may comprise at least one selected from the group consisting of Br⁻, AlCl₄⁻, Al₂Cl₇⁻, NO₃⁻, BF₄⁻, PF₆⁻, CH₃COO⁻, CF₃COO⁻, CF₃CO₃⁻, CF₃SO₃⁻, (CF₃SO₂)₂N⁻, (CF₃SO₂)₃C⁻, AsF₆⁻, SbF₆⁻, CF₃(CF₂)₃SO₃⁻, (CF₃CF₂SO₂)₂N⁻, CF₃CF₂CF₂COO⁻, (FSO₂)₂N⁻, and combinations thereof. The anion, together with the cation, can exhibit excellent compatibility with materials in the adhesive composition, for example, the (meth)acrylate-based monomer and the like. Accordingly, it is possible to exhibit excellent properties while including an adhesive layer that is a photocured product not including a solvent. The anion may have, for example, a sulfonyl group. For example, the anion may be (CF₃SO₂)₂N⁻.

For example, the ionic liquid may be 1-butyl-3-methylimidazolium bis(trifluoromethylsulfonyl)imide.

When a voltage is applied to the electrically variable adhesive sheet, as electricity passes therethrough, the imidazolium cation of the ionic liquid may be electrochemically reduced to a carbene. The carbene may react with —CO— included in the adhesive layer to break bonding at an interface between the adhesive layer and a conductive substrate. In addition, hydrogen (H₂) gas may be generated during the process of reduction to the carbene, and the generated hydrogen gas can physically promote peeling.

The ionic liquid may be included in an amount of 2 to 30 parts by weight based on 100 parts by weight of the total content of the binder resin and the (meth)acrylate-based monomer. Accordingly, it is possible to prevent reliability defects of the adhesive layer, prevent the generation of a large amount of bubbles during the formation of the adhesive layer, and allow adhesive strength to be sufficiently lowered upon application of a voltage, but the present disclosure is not limited thereto.

### <UV Initiator>

The adhesive composition includes a UV initiator, and may be photocured to form an adhesive layer.

The UV initiator may include at least one selected from the group consisting of alpha-hydroxyketone-based initiators, phenylglyoxylate-based initiators, benzyldimethyl-ketal-based initiators, alpha-aminoketone-based initiators, monoacylphosphine-based initiators, bisacylphosphine-based initiators, phosphine oxide-based initiators, metallocene-based initiators, iodonium salt-based initiators, and combinations thereof. For example, the UV initiator may include at least one selected from 1-hydroxycyclohexyl phenyl ketone, 1-hydroxy-2-methyl-1-phenyl-propan-1-one, diphenyl 2,4,6-trimethylbenzoyl phosphine oxide, and 2,2-dimethoxy-2-phenylacetophenone. More preferably, the UV initiator may include 2,2-dimethoxy-2-phenylacetophenone. The UV initiator may be included in an amount of 0.1 to 0.5 parts by weight based on 100 parts by weight of the total content of the binder resin and the (meth)acrylate-based monomer. Accordingly, it is possible to prevent the cohesive strength of the adhesive layer from becoming insufficient, or the adhesive strength at room temperature from being lowered, but the present disclosure is not limited thereto.

### <Electrically Variable Adhesive Sheet>

The electrically variable adhesive sheet includes an adhesive layer which is a photocured product of the adhesive composition. The adhesive layer may have a thickness of 10 μm to 300 μm.

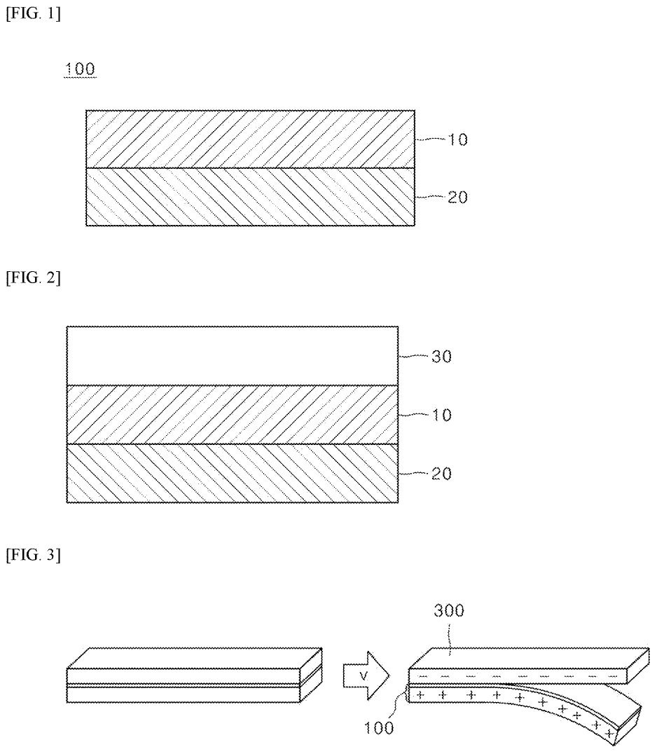

As shown in FIG. 1, the electrically variable adhesive sheet may include a metal layer on one surface of the adhesive layer.

The metal layer may include at least one selected from alloys selected from the group consisting of iron, manganese, chromium, copper, aluminum, nickel, zinc, lead, tin, tungsten, magnesium, gold, silver, titanium, and combinations thereof. For example, the metal layer may be an alloy of aluminum and manganese. For example, it may be an aluminum 3003 series. The electrically variable adhesive sheet can further improve corrosion resistance and strength by including the metal layer. The metal layer may have a thickness of 30 μm to 60 km.

As shown in FIG. 2, the electrically variable adhesive sheet may have a three-layer structure further including a release film on the other surface of the adhesive layer. The release film serves to protect the surface of the adhesive layer. The release film is not particularly limited, and may be a release film in which the surface of a substrate such as paper or a plastic film is silicone-treated, a release film in which the surface of a substrate such as paper or a plastic film is laminated with a polyolefin-based resin, or the like.

The electrically variable adhesive sheet may be attached to a conductive material. The conductive material is preferably an adherend having a metal adherend surface. Examples of the adherend having a metal adherend surface include those made of a metal containing aluminum, copper, iron, magnesium, tin, gold, silver, lead, and the like as a main component, and among these, a metal including aluminum is preferable.

The electrically variable adhesive sheet may exhibit an initial (room temperature) adhesive strength of 10 N/inch or more with respect to the adherend. Accordingly, adhesive strength with the adherend can be sufficient so that the adherend is prevented from being peeled off or displaced. The initial (room temperature) adhesive strength means adhesive strength when no voltage is applied.

The electrically variable adhesive sheet may have an adhesive strength of 10 N/inch or more as measured after 500 hours at 85 °C and 85% relative humidity (R.H.). Accordingly, the electrically variable adhesive sheet can exhibit excellent adhesive strength even under high temperature and high humidity, thereby providing excellent environmental reliability. The adhesive strength is a larger-the-better characteristic, in which higher values are preferable, but may be, for example, 30 N/inch or less, without being limited thereto.

As shown in FIG. 3, the electrically variable adhesive sheet can be peeled by reducing the adhesive strength by applying a voltage to generate a potential difference in a thickness direction of the adhesive layer. For example, a bonded body in which the electrically variable adhesive sheet is attached to a conductive adherend can be peeled by applying current to the conductive adherend and applying a voltage to the electrically peelable adhesive layer.

In this case, it is preferable to perform the current application by connecting terminals to one end and the other end of the electrically variable adhesive sheet so that a voltage is applied to the entire adhesive layer of the electrically variable adhesive sheet. In addition, when the adherend has a metal adherend surface, the one end and the other end may be a part of the adherend having a metal adherend surface.

In this case, the applied voltage may be 30 V to 100 V. In addition, the voltage application time may be 1 minute to 60 minutes.

When a voltage of 60 V is applied to the electrically variable adhesive sheet, the adhesive strength is lost by 90% or more over time, so that the sheet can be easily peeled.

The electrically variable adhesive sheet may have an adhesive strength of 0 to 1 N/inch after application of a voltage of 60 V for 10 minutes. For example, when the adhesive strength after application of a voltage of 60 V for 10 minutes exceeds 1 N/inch, the adhesive of the adhesive layer may remain on the conductor, and thus, an additional process for removing the same may be required, which is uneconomical.

The electrically variable adhesive sheet may be used for a battery package.

Conventional re-peelable adhesive sheets include an adhesive layer peeled by ultraviolet (UV) irradiation, or an adhesive layer peeled by heat, and the like. In the adhesive sheet using such an adhesive layer, there is a problem in that it cannot be used in cases where ultraviolet (UV) irradiation is difficult or where a member as an adherend is damaged by heat, etc. Since the electrically variable adhesive sheet is not peeled by ultraviolet rays or heat, the material may not be subject to restrictions due to concerns about damage to a member serving as an adherend, and the like. The electrically variable adhesive sheet can be easily peeled by applying a voltage. Thus, it may be suitable for use in a battery package, which may not be peeled by heat or UV irradiation.

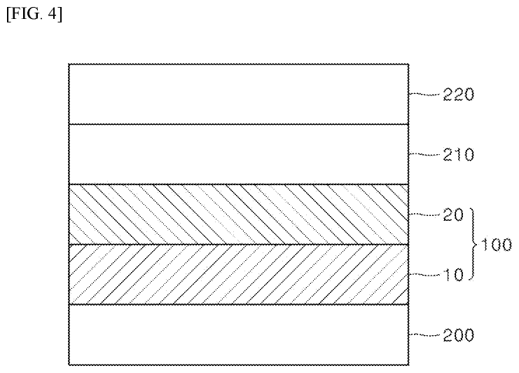

FIG. 4 schematically illustrates that the electrically variable adhesive sheet is used for a battery package in one embodiment of the present disclosure. As shown in FIG. 4, the electrically variable adhesive sheet may be used with the adhesive layer attached to a cooling plate. In addition, the electrically variable adhesive sheet can be easily peeled from the cooling plate when a voltage is applied.

For example, the adhesive layer of the electrically variable adhesive sheet may be attached to the cooling plate, and the other surface of the metal layer may be attached to a cell through an adhesive. In one example, the adhesive may be a heat-dissipating adhesive.

According to another embodiment of the present disclosure, there is provided a method for manufacturing the electrically variable adhesive sheet. The manufacturing method is not particularly limited as long as it manufactures the above-described adhesive layer and the electrically variable adhesive sheet including the same, but according to one embodiment, the method for manufacturing the electrically variable adhesive sheet is as follows.

Specifically, the method for manufacturing the electrically variable adhesive sheet includes: preparing a mixture by mixing a (meth)acrylate-based monomer and an ionic liquid; and preparing an adhesive composition by mixing a binder resin and a UV initiator with the mixture. An electrically variable adhesive sheet including the above-described adhesive layer may be manufactured by the manufacturing method. Matters relating to the adhesive composition and the adhesive layer are as described above unless otherwise specifically described below.

Since the adhesive composition is a solvent-free composition and is a photocured product, solubility of the ionic liquid in the adhesive composition and compatibility with the (meth)acrylate-based monomer and the like may become problematic. Accordingly, the properties of the electrically variable adhesive sheet may also deteriorate.

The electrically variable adhesive sheet may be manufactured according to the aforementioned manufacturing method, and accordingly, compatibility between the ionic liquid and materials included in the adhesive composition, for example, compatibility with the (meth)acrylate-based monomer, can be more enhanced.

Specifically, the manufacturing method first includes preparing a mixture by mixing the (meth)acrylate-based monomer and the ionic liquid. In contrast, when the binder resin and the ionic liquid are mixed first, or when the binder resin, the (meth)acrylate-based monomer, and the ionic liquid are mixed simultaneously, the composition may easily change into a gel form, making it difficult to secure the properties.

The manufacturing method includes preparing an adhesive composition by mixing a binder resin and a UV initiator with a mixture formed by mixing the (meth)acrylate-based monomer and the ionic liquid. Accordingly, the solubility of the composition can be better adjusted. Thus, the desired properties can be easily adjusted.

The manufacturing method may further include forming an adhesive layer by applying the adhesive composition on one surface of a release film and photocuring it by irradiating UV.

In the application, conventional coaters (for example, a gravure roll coater, a reverse roll coater, a kiss roll coater, a dip roll coater, a bar coater, a knife coater, a spray roll coater, and the like) may be used.

The UV irradiation may be performed at 8 mW/cm² and 1,800 mJ/cm² to effect photocuring.

Thereafter, the manufacturing method may further include attaching a metal layer to the other surface of the adhesive layer to which the release film is not attached.

### EXAMPLES

### Example 1

30 parts by weight of a monomer composed of 15 parts by weight of isobornyl acrylate (IBOA) and 15 parts by weight of 2-ethylhexyl acrylate (EHA) was prepared. Then, 1-butyl-3-methylimidazolium bis(trifluoromethylsulfonyl)imide was mixed with the monomer to prepare a mixture.

Then, 70 parts by weight of an acrylate-based resin was mixed with the mixture, and 2,2-dimethoxy-2-phenylacetophenone as a UV initiator was mixed to prepare an adhesive composition. In this case, the adhesive composition was prepared such that the ionic liquid was included in an amount of 10 parts by weight and the UV initiator was included in an amount of 0.2 parts by weight, based on 100 parts by weight of the total content of the acrylate-based resin, which is the binder resin, and the monomer.

The adhesive composition was applied onto a silicone-treated surface of a polyethylene terephthalate release film having a silicone-treated surface using an applicator so as to have a uniform thickness. Then, UV was irradiated at 8 mW/cm² and 1,800 mJ/cm² to effect photocuring, thereby preparing an adhesive layer (adhesive film) having a thickness of 90 μm.

Then, the adhesive layer was attached to one surface of a metal layer (Al foil) having a thickness of 50 μm to manufacture an electrically variable adhesive sheet (release film/adhesive layer/metal layer).

### Example 2

Adhesive layers and electrically variable adhesive sheets including the same were manufactured in the same manner as in Example 1, except that the ionic liquid of Example 1 was changed to 1-propyl-3-methylimidazolium bis(trifluoromethylsulfonyl)imide.

### Comparative Examples 1 to 3

Adhesive layers and electrically variable adhesive sheets including the same were prepared in the same manner as in Example 1, except that the ionic liquid of Example 1 was changed to 1-ethyl-3-methylimidazolium trifluoromethanesulfonate in Comparative Example 1, to 1-ethyl-3-methylimidazolium ethyl sulfate in Comparative Example 2, and to 1-methyl-3-octylimidazolium bis(trifluoromethylsulfonyl)imide in Comparative Example 3, respectively, as shown in Table 1.

TABLE 1

| | | Example | Example | Comparative | Comparative | Comparative |
|---|---|---|---|---|---|---|
| | | 1 | 2 | Example 1 | Example 2 | Example 3 |
| Ionic | 1-butyl-3- | ◯ | | | | |
| liquid | methylimidazolium | | | | | |
| | bis(trifluoromethylsulfonyl) | | | | | |
| | imide | | | | | |
| | 1-propyl-3- | | ◯ | | | |
| | methylimidazolium | | | | | |
| | bis(trifluoromethylsulfonyl) | | | | | |
| | imide | | | | | |
| | 1-ethyl-3- | | | ◯ | | |
| | methylimidazolium | | | | | |
| | trifluoromethanesulfonate | | | | | |
| | 1-ethyl-3- | | | | ◯ | |
| | methylimidazolium ethyl | | | | | |
| | sulfate | | | | | |
| | 1-methyl-3- | | | | | ◯ |
| | octylimidazolium | | | | | |
| | bis(trifluoromethylsulfonyl) | | | | | |
| | imide | | | | | |

### Evaluation

### Experimental Example 1: Compatibility

For each of the adhesive compositions of the Examples and Comparative Examples, an adhesive composition was prepared by mixing each ionic liquid in an amount of 20 parts by weight based on 100 parts by weight of the total content of 70 parts by weight of the (meth)acrylate-based resin, which is the binder resin, and 30 parts by weight of the (meth)acrylate-based monomer.

Then, when the mixed adhesive compositions were stirred for 10 minutes, it was visually checked whether any precipitation occurred (immiscible).

When the adhesive composition was transparent and well mixed, it was indicated as good (miscible), and when precipitation occurred, it was indicated as precipitated (immiscible), which are shown in Table 2.

### Experimental Example 2: Initial (Room Temperature) Adhesive Strength (900 Peel Strength)

Each of the electrically variable adhesive sheet (Al foil/adhesive layer) of the Examples and Comparative Examples was cut to a size of 25 mm (width)×150 mm (length) to prepare specimens. The adhesive layer of the specimen was attached to a metal plate (Al plate), left at 25 °C for 1 hour, and then peeled at 900 from the metal plate at a speed of 300 mm/min using a universal testing machine (UTM, Surta UTM) to measure adhesive strength.

### Experimental Example 3: Adhesive Strength after Application of Voltage (90° Peel Strength)

Each of the electrically variable adhesive sheet (Al foil/adhesive layer) of the Examples and Comparative Examples was cut to a size of 25 mm (width)×150 mm (length) to prepare specimens. The adhesive layer of the specimen was attached to a metal plate (Al plate) and left at 25 °C for 1 hour. Thereafter, as shown in FIG. 3, using a DC supplier, a cathode (−) was set to the metal plate (Al plate) and an anode (+) was set to the Al foil, and a direct current voltage of 60 V was applied for 10 minutes. Then, adhesive strength was measured by peeling the specimen from the metal plate at 90° at a speed of 300 mm/min using a universal testing machine (UTM, Surta UTM).

### Experimental Example 4: Adhesive Strength (High Temperature and High Humidity)

Each of the electrically variable adhesive sheet (Al foil/adhesive layer) of the Examples and Comparative Examples was cut to a size of 25 mm (width)×150 mm (length) to prepare specimens. The adhesive layer of the specimen was attached to a metal plate (Al plate) and left at 25 °C for 1 hour to be stabilized. Then, the specimen was left for 500 hours under conditions of 85 °C and 85% relative humidity (RH). Then, after being left at room temperature (25 °C) for one day, adhesive strength was measured by 90° peeling at a speed of 300 mm/min using a universal testing machine (UTM, Surta UTM).

TABLE 2

| | | | | Comparative | Comparative | Comparative |
|---|---|---|---|---|---|---|
| | | Example 1 | Example 2 | Example 1 | Example 2 | Example 3 |
| Compatibility | | Good | Good | Precipitated | Precipitated | Good |
| Adhesive | Initial (room | 15.4 | 10.2 | — | — | 18.7 |
| strength | temperature) | | | | | |
| (N/inch) | After application | 0.7 | 0.5 | — | — | 15.3 |
| | of voltage | | | | | |
| | (60 V, 10 min) | | | | | |
| | 85 °C, 85% RH, | 14.2 | 12.1 | — | — | 8.4 |
| | 500 hours | | | | | |

As shown in Table 2, it was confirmed that the Examples exhibited excellent environmental reliability by showing excellent adhesive strength even after being subjected to a high-temperature and high-humidity environment, with an adhesive strength of 10 N/inch or more as measured after 500 hours at 85 °C and 85% relative humidity (RH). In contrast, it was confirmed that Comparative Examples 1 and 2 were difficult to use as adhesive sheets due to precipitation, and that Comparative Example 3 exhibited reduced adhesive strength after being subjected to a high-temperature and high-humidity environment and thus could not secure environmental reliability.

Although the present disclosure has been described above, the present disclosure is not limited to the embodiments disclosed in this specification, and it is obvious that various modifications can be made by those skilled in the art within the scope of the technical idea of the present disclosure. In addition, even if the operations and effects according to the configuration of the present disclosure were not explicitly described while describing the embodiments of the present disclosure, it is natural that the effects predictable by the corresponding configuration should also be recognized.

### DESCRIPTION OF REFERENCE NUMERALS

100: electrically variable adhesive sheet
10: adhesive layer
20: metal layer
30: release film
200: cooling plate
210: heat-dissipating adhesive
220: cell
300: metal plate

What is claimed is:

1. An electrically variable adhesive sheet comprising:
an adhesive layer which is a photocured product of an adhesive composition including a binder resin, a (meth)acrylate-based monomer, a UV initiator, and an ionic liquid, and
having an adhesive strength of 10 N/inch or more as measured after 500 hours at 85 °C and 85% relative humidity (R.H.).

2. The electrically variable adhesive sheet of claim 1, wherein the binder resin comprises at least one UV-curable resin selected from the group consisting of a (meth)acrylate-based resin and a urethane acrylate-based resin.

3. The electrically variable adhesive sheet of claim 1, wherein the (meth)acrylate-based monomer includes ethyl (meth)acrylate, butyl (meth)acrylate, ethylhexyl (meth)acrylate, isobornyl (meth)acrylate, or a combination thereof.

4. The electrically variable adhesive sheet of claim 1, wherein the ionic liquid includes a cation having the structure of Formula 1 below: 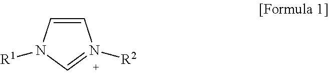
wherein R₁ is a linear or branched alkyl group having 3 or more carbon atoms, and
R² is a linear or branched alkyl group having 1 to 2 carbon atoms.

5. The electrically variable adhesive sheet of claim 1, wherein an anion of the ionic liquid comprises at least one selected from the group consisting of Br⁻, AlCl₄⁻, Al₂Cl₇⁻, NO₃⁻, BF₄⁻, PF₆⁻, CH₃COO⁻, CF₃COO⁻, CF₃CO₃⁻, CF₃SO₃⁻, (CF₃SO₂)₂N⁻, (CF₃SO₂)₃C⁻, AsF⁻, SbF⁻, CF₃(CF₂)₃SO₃⁻, (CF₃CF₂SO₂)₂N⁻, CF₃CF₂CF₂COO⁻, (FSO₂)₂N⁻, and combinations thereof.

6. The electrically variable adhesive sheet of claim 1, wherein the UV initiator comprises at least one selected from the group consisting of alpha-hydroxyketone-based initiators, phenylglyoxylate-based initiators, benzyldimethyl-ketal-based initiators, alpha-aminoketone-based initiators, monoacylphosphine-based initiators, bisacylphosphine-based initiators, phosphine oxide-based initiators, metallocene-based initiators, iodonium salt-based initiators, and combinations thereof.

7. The electrically variable adhesive sheet of claim 1, wherein the electrically variable adhesive sheet exhibits a decrease in adhesive strength upon application of a voltage, and
has an adhesive strength of 0 to 1 N/inch after application of a voltage of 60 V for 10 minutes.

8. The electrically variable adhesive sheet of claim 1, wherein the electrically variable adhesive sheet includes a metal layer on one surface of the adhesive layer, or
includes a metal layer on one surface of the adhesive layer and a release film on the other surface thereof, and
wherein the adhesive layer has a thickness of 10 μm to 300 μm.

9. The electrically variable adhesive sheet of claim 1, wherein the electrically variable adhesive sheet is for a battery package.
